(19) United States
(12) Patent Application Publication
(10) Pub. No.: US 2025/0216200 A1
(43) Pub. Date: Jul. 3, 2025

(54) GYRO SENSOR AND METHOD FOR CONTROLLING GYRO SENSOR

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Keitaro ITO, Nisshin-shi (JP); Shota HARADA, Nisshin-shi (JP)

(21) Appl. No.: 18/913,370

(22) Filed: Oct. 11, 2024

(30) Foreign Application Priority Data
Dec. 27, 2023 (JP) 2023-221264

(51) Int. Cl. G01C 19/5776

(52) U.S. Cl. CPC G01C 19/5776

(57) ABSTRACT

A gyro sensor includes a control unit that controls a resonator. The control unit includes: a detection gain ratio corrector that corrects a detection gain ratio between a gain of a first detection signal from a first detection electrode that detects vibration of the resonator on the x-axis and a gain of a second detection signal from a second detection electrode that detects vibration of the resonator on the y-axis; a drive gain ratio corrector that corrects a drive gain ratio between a gain of the first drive signal to a first drive electrode in the first vibration mode and a gain of the second drive signal to a second drive electrode in the second vibration mode; and a bias error corrector that calculates an angle at which the angular velocity becomes a value closest to zero after correction of the detection gain ratio and the drive gain ratio.

### CROSS REFERENCE TO RELATED APPLICATION

This application is based on Japanese Patent Application No. 2023-221264 filed on Dec. 27, 2023, the disclosure of which is incorporated herein by reference.

### TECHNICAL FIELD

The present disclosure relates to a gyro sensor and a method for controlling a gyro sensor.

### BACKGROUND

A gyro sensor includes a resonator having two vibration modes having different resonance angle frequencies, and electrodes surrounding the resonator, so as to apply electrostatic force from a part of the electrodes to the resonator to vibrate in a resonance mode, and detects an angular velocity applied from outside.

### SUMMARY

According to an aspect of the present disclosure, a gyro sensor includes: a resonator having a first vibration mode and a second vibration mode having different resonance angle frequencies; a mounting substrate including a plurality of electrodes facing the resonator; and a control unit that performs drive control of the resonator. A radial direction is defined about a virtual straight line along a thickness direction of the mounting substrate and passing through a center of a region surrounded by the plurality of electrodes. An x axis is the radial direction along a vibration direction of the first vibration mode, and a y axis is the radial direction along a vibration direction of the second vibration mode. The control unit includes: a first phase locked loop (PLL) that performs frequency control of a first drive signal for driving the resonator in the first vibration mode; a second PLL that performs frequency control of a second drive signal for driving the resonator in the second vibration mode; a detection gain ratio corrector that corrects a detection gain ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes; a drive gain ratio corrector that corrects a drive gain ratio between a gain of the first drive signal to a first drive electrode for vibrating the resonator in the first vibration mode among the plurality of electrodes and a gain of the second drive signal to a second drive electrode for vibrating the resonator in the second vibration mode among the plurality of electrodes; a first demodulation block that performs calculation of a first demodulation output based on the first detection signal and the first drive signal and a second demodulation output based on the first detection signal and the second drive signal; a second demodulation block that performs calculation of a third demodulation output based on the second detection signal and the first drive signal and a fourth demodulation output based on the second detection signal and the second drive signal; a first automatic gain control (AGC) that calculates a drive output for maintaining an amplitude in resonant drive of the resonator in the first vibration mode on a basis of an output signal from the first demodulation block; a second AGC that calculates a drive output for maintaining an amplitude in resonant vibration of the resonator in the second vibration mode on a basis of an output signal from the second demodulation block; an angular velocity calculator that executes calculation of an angular velocity applied from outside; and a bias error corrector that calculates an angle at which the angular velocity calculated by the angular velocity calculator becomes a value closest to zero after correction of the detection gain ratio and the drive gain ratio, and determines the angle as a detection direction and a drive direction of vibration of the resonator.

A method for controlling the gyro sensor includes: maintaining resonant drive of the resonator in the first vibration mode and the second vibration mode by using two PLLs; calculating and determining the detection gain ratio; calculating and determining the drive gain ratio; after determining the detection gain ratio and the drive gain ratio, while performing angle input and sweeping of a detection direction and a drive direction of vibration of the resonator in a range of 0° to 360°, calculating an angular velocity or a drive output for vibrating the resonator for each input angle and determining a value at which the angular velocity is closest to zero as a command value; and determining the detection direction and the drive direction as an angle of the command value and measuring an angular velocity.

### BRIEF DESCRIPTION OF DRAWINGS

FIG. 1 is a perspective view illustrating an exemplary structure of a sensor element.

FIG. 2 is a sectional view illustrating a sectional configuration taken along line II-II in FIG. 1.

FIG. 3 is a diagram corresponding to FIG. 2, and is a sectional view illustrating another exemplary structure.

FIG. 4 is an explanatory diagram of a vibration axis and an electrode axis of the sensor element.

FIG. 5 is a diagram illustrating a two-dimensional vibration model of a resonator of the gyro sensor.

FIG. 6 is an explanatory diagram of a relationship between a zero-point bias output and a vibration direction.

FIG. 7 is a block diagram of a gyro sensor according to an embodiment.

FIG. 8 is an explanatory diagram of a first vibration mode and a second vibration mode in the resonator vibrating in a wineglass mode.

FIG. 9 is an explanatory diagram of a demodulation output calculated by a demodulation block.

FIG. 10 is a block diagram illustrating a calculation mode of a gain ratio.

FIG. 11 is an explanatory diagram of first calculation of a detection gain ratio.

FIG. 12 is an explanatory diagram of second calculation of the detection gain ratio.

FIG. 13 is an explanatory diagram of third calculation of the detection gain ratio.

FIG. 14 is an explanatory diagram of calculation of a drive gain ratio.

### DESCRIPTION OF EMBODIMENTS

A gyro sensor includes a resonator having two vibration modes having different resonance angle frequencies, and electrodes surrounding the resonator, to apply electrostatic force from a part of the electrodes to the resonator to vibrate in a resonance mode, and detects an angular velocity applied from outside. This type of gyro sensor outputs a signal corresponding to an angular velocity applied from the outside on the basis of electrostatic capacitance between the electrode and the resonator, but there is a signal output due to a zero point error even in a state where the angular velocity is not applied. Hereinafter, for convenience of description, the signal output from the gyro sensor in a state where the angular velocity is not applied is referred to as “zero-point bias output”.

A main factor of the zero-point bias output is a component derived from asymmetry of the resonator, and is specifically known to be caused by a difference Δ(1/T) and θ_{T} between Quality factor of the vibration axes x and y of the resonator. The zero-point bias output is expressed by the following equation (1).

$$Zero - point bias output = ( 1 / 2 η ) Δ ( 1 / ⊤ ) sin 2 {θ}_{⊤} \qquad ( 1 )$$

In the equation (1), η is a constant determined by a structure of the resonator called angular gain, T is a time constant, and θ_{T} is an angle formed between a damper axis of the resonator and an electrode axis along an electrode that drives the resonator and detects vibration.

It may be possible to reduce the zero-point bias output by adopting a method called mode deflection in which a mode is deflected onto a damping axis such that the bias becomes zero by using Δ(1/T) sin 2θ_{T} that is a component of the zero-point bias output as a bias.

However, even when the above mode is deflected onto the damping axis, that is, even when the gyro operation is performed in a direction in which the bias output by θ_{T} is the smallest, a residual can occur in the zero-point bias output. In a case where there is a gain ratio between the two vibration axes of the resonator in the drive signal of the resonator and the detection signal of the vibration, a residual occurs in the zero-point bias output, and the zero-point bias output cannot be minimized. For example, in a state where the direction in which the drive command is issued to the resonator is different from an actual vibration direction of the resonator, or in a state where an actual vibration angle of the resonator is different from a vibration angle read from a voltage value, a residual occurs in the zero-point bias output.

It is also conceivable to perform numerical correction such that the zero-point bias output represented by the equation (1) becomes zero on the system by calibration or the like. However, since the zero-point bias output may fluctuate due to an influence of a temperature change, a temporal change, or the like in an operation state, in such a case, the effect of reducing the zero-point bias output by calibration or the like is weakened. In this method, it is not possible to cope with a case where there is a gain ratio between the two vibration axes in the detection signal and the drive signal.

The present disclosure provides a gyro sensor capable of reducing a gain ratio influence between two vibration axes of a signal of drive and detection of a resonator and minimizing a zero-point bias output, and a method for controlling the gyro sensor.

A gyro sensor includes: a resonator having a first vibration mode and a second vibration mode having different resonance angle frequencies; a mounting substrate including a plurality of electrodes facing the resonator; and a control unit that performs drive control of the resonator. When a radial direction that passes through a center of a region surrounded by the plurality of electrodes and has, as an axis, a virtual straight line along a thickness direction of the mounting substrate includes a direction along a vibration direction of the first vibration mode as an x axis and a direction along a vibration direction of the second vibration mode as a y axis. The control unit includes a first PLL that performs frequency control of a first drive signal for driving the resonator in the first vibration mode, a second PLL that performs frequency control of a second drive signal for driving the resonator in the second vibration mode, a detection gain ratio corrector that corrects a detection gain ratio that is a ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes, a drive gain ratio corrector that corrects a drive gain ratio that is a ratio between a gain of the first drive signal to a first drive electrode for vibrating the resonator in the first vibration mode among the plurality of electrodes and a gain of the second drive signal to a second drive electrode for vibrating the resonator in the second vibration mode among the plurality of electrodes, a first demodulation block that performs calculation of a first demodulation output based on the first detection signal and the first drive signal and a second demodulation output based on the first detection signal and the second drive signal, a second demodulation block that performs calculation of a third demodulation output based on the second detection signal and the first drive signal and a fourth demodulation output based on the second detection signal and the second drive signal, a first AGC that calculates a drive output for maintaining an amplitude in resonant drive of the resonator in the first vibration mode on a basis of an output signal from the first demodulation block, a second AGC that calculates a drive output for maintaining an amplitude of the resonator in resonant vibration in the second vibration mode on a basis of an output signal from the second demodulation block, an angular velocity calculator that executes calculation of an angular velocity applied from outside, and a bias error corrector that calculates an angle at which the angular velocity calculated by the angular velocity calculator becomes a value closest to zero after correction of the detection gain ratio and the drive gain ratio, and determines the angle as a detection direction and a drive direction of vibration of the resonator.

In this gyro sensor, the gain ratio of each of the detection signal and the drive signal of the x axis and the y axis of the resonator is corrected by the detection gain ratio corrector and the drive gain ratio corrector, and the influence of the gain ratio on the x axis and the y axis of the signal of drive and detection of the resonator is reduced. In the gyro sensor, after the gain ratio between the detection gain ratio and the drive gain ratio is corrected, the angular velocity is corrected to a value closest to zero for the detection direction and the drive direction, and the zero-point bias output is minimized.

A method for controlling the gyro sensor includes: maintaining resonant drive of the resonator in the first vibration mode and the second vibration mode by using two PLLs; when a radial direction that passes through a center of a region surrounded by the plurality of electrodes and has, as an axis, a virtual straight line along a thickness direction of the mounting substrate includes a direction along a vibration direction of the first vibration mode as an x axis and a direction along a vibration direction of the second vibration mode as a y axis, calculating and determining a detection gain ratio that is a ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes; calculating and determining a drive gain ratio that is a ratio of a gain of a first drive signal to a first drive electrode for vibrating the resonator on the x axis among the plurality of electrodes to a gain of a second drive signal to a second drive electrode for vibrating the resonator on the y axis among the plurality of electrodes; after determining the detection gain ratio and the drive gain ratio, while performing angle input and sweeping of a detection direction and a drive direction of vibration of the resonator in a range of 0° to 360°, calculating an angular velocity or a drive output for vibrating the resonator for each input angle and determining a value at which the angular velocity is closest to zero as a command value; and determining the detection direction and the drive direction as an angle of the command value and measuring an angular velocity.

In this control method of the gyro sensor, a detection gain ratio that is a gain ratio of detection signals of the x axis and the y axis of the resonator is determined by calculation, and a drive gain ratio that is a gain ratio of drive signals of the x axis and the y axis is determined by calculation. As a result, an error due to the gain ratio between the x axis and the y axis of the detection signal and the drive signal is reduced. Then, in the control method, after the detection gain ratio and the drive gain ratio are corrected, the input angle is swept in the detection direction and the drive direction in the range of 0° to 360°, the value in which the angular velocity is closest to zero is determined as the command value, and the angular velocity is measured with the command value. As a result, the control method of the gyro sensor can reduce the influence of the gain ratio in the x axis and the y axis of the signal of drive and detection of the resonator and to minimize the zero-point bias output.

Hereinafter, embodiments of the present disclosure will be described with reference to the drawings. In the following embodiments, the same or equivalent portions are denoted by the same reference signs, and the description thereof will be made.

### First Embodiment

A gyro sensor 1 according to a first embodiment will be described with reference to the drawings.

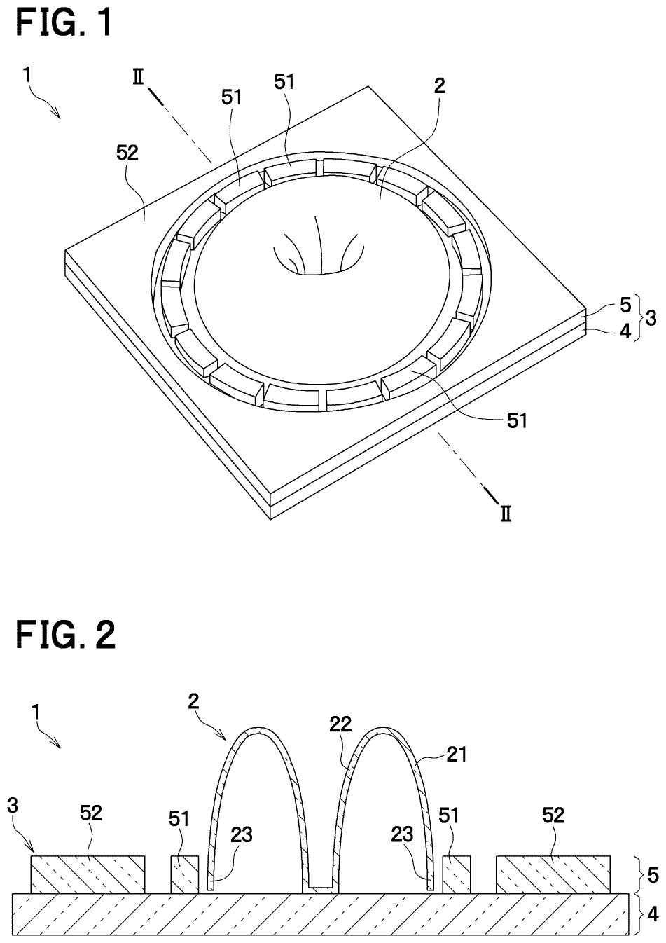

As illustrated in FIG. 1, for example, the gyro sensor 1 according to the present embodiment includes a resonator 2 and a mounting substrate 3. A sensor element is formed, in which the resonator 2 is mounted on the mounting substrate 3. The gyro sensor 1 can detect an angular velocity and a rotation angle applied to the gyro sensor 1 on the basis of a change in electrostatic capacitance between a part of the thin resonator 2 capable of vibrating in a first vibration mode and a second vibration mode and a plurality of first electrode portions 51 of the mounting substrate 3. The gyro sensor 1 can perform control of minimizing a zero-point bias output by a control unit 10 to be described later.

For example, as illustrated in FIG. 2, the resonator 2 is a minute vibrating body having a three-dimensional substantially symmetrical structure including a curved surface 21 including an outer shape of a substantially hemispherical three-dimensional curved surface, and a mounting portion 22 extending from a vertex side of a virtual hemisphere formed by the curved surface 21 toward a center of the hemisphere. In the resonator 2, for example, conductive films (not illustrated) are formed on both a front surface and a back surface, and a voltage can be applied from the mounting substrate 3. In the resonator 2, for example, a rim 23 which is an end of the curved surface 21 on a side opposite to the mounting portion 22 faces the plurality of first electrode portions 51, and the rim 23 vibrates in a resonance mode due to an electrostatic force from the first electrode portion 51.

Note that the resonator 2 can be manufactured, for example, by preparing a plate material including any reflow material such as quartz and a mold having a bowl-shaped recess and a support column located at a center of the recess, setting the plate material in the mold, and heating and softening the recess while decompressing the recess.

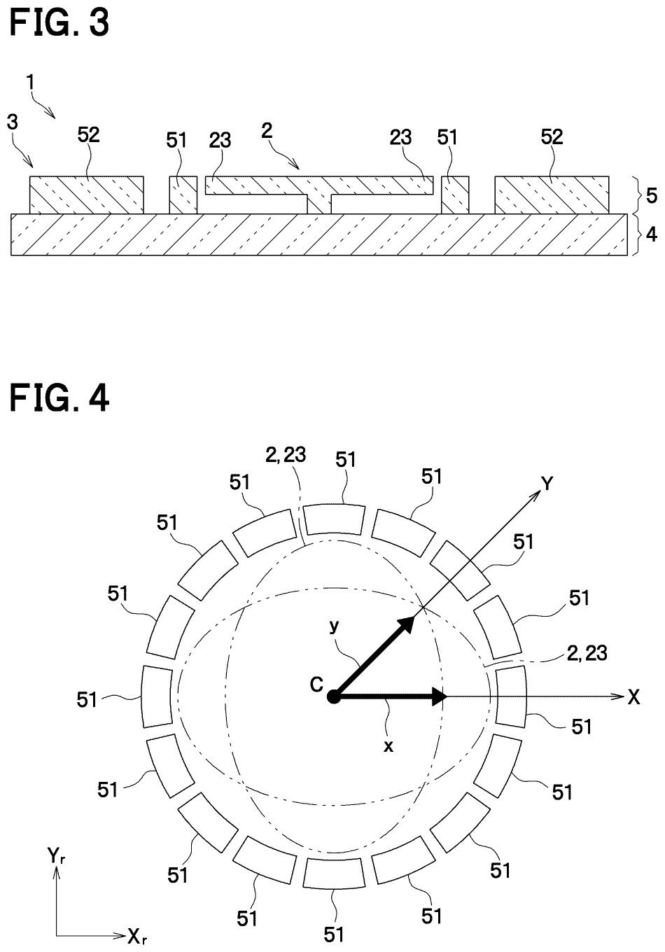

Alternatively, for example, as illustrated in FIG. 3, the resonator 2 may have a substantially disk shape having a disk-shaped portion and a columnar connection portion bonded to the mounting substrate 3 at a center of the disk-shaped portion. In this case, in the resonator 2, an end of a hollow disk-shaped portion is the rim 23, and the portion is surrounded by the plurality of first electrode portions 51. As described above, the resonator 2 only needs to have a structure capable of vibrating in the first vibration mode and the second vibration mode by a drive electrode among the plurality of first electrode portions 51, and may have another known structure other than the above structure.

For example, as illustrated in FIGS. 1 and 2, the mounting substrate 3 includes a lower substrate 4 and an upper substrate 5, and these substrates are bonded to each other. For example, the mounting substrate 3 is obtained by performing wiring film formation or the like on the lower substrate 4 including borosilicate glass as an insulating material, then anodically bonding the upper substrate 5 including silicon as a semiconductor material to the lower substrate 4, and performing patterning. In the mounting substrate 3, for example, dry etching such as DRIE is performed on the upper substrate 5 after anodic bonding to form the plurality of first electrode portions 51 and second electrode portions 52. The DRIE is an abbreviation for deep reactive ion etching. In the mounting substrate 3, for example, in a case where the resonator 2 has a bird bus shape illustrated in FIG. 2, an annular groove (not illustrated) along the rim 23 may be formed in the lower substrate 4 as necessary so as not to come into contact with the rim 23.

The plurality of first electrode portions 51 surrounds the rim 23 of the resonator 2, for example, and is arranged apart from each other at equal intervals so as to form one ring on a plane of the mounting substrate, and an electrode film (not illustrated) is formed on each top surface. The potential of the plurality of first electrode portions 51 can be controlled by, for example, connecting a wire (not illustrated) to the electrode film (not illustrated) and electrically connecting the electrode film to an external circuit board or the like. All of the plurality of first electrode portions 51 are separated from the rim 23 of the resonator 2 by a predetermined distance, each of the first electrode portions forms the resonator 2 and a capacitor, and electrostatic capacitance between the first electrode portions and the resonator 2 can be detected. Some of the plurality of first electrode portions 51 are detection electrodes that detect electrostatic capacitance, and the others are drive electrodes that apply electrostatic force to the rim 23 of the resonator 2.

For example, as illustrated in FIG. 1, the second electrode portion 52 has a single frame shape surrounding the plurality of first electrode portions 51, an electrode film (not illustrated) is formed on the top surface, and a wire (not illustrated) is connected to the electrode film (not illustrated). The second electrode portion 52 is connected to a conductive film (not illustrated) of the resonator 2 by wiring (not illustrated) or the like, and is configured to be capable of voltage application.

The above is a basic configuration of the sensor element of the gyro sensor 1 according to the present embodiment. The control unit 10 that executes drive control of the gyro sensor 1 will be described later.

FIG. 1 illustrates, as a representative example, a case where the mounting substrate 3 has 16 first electrode portions 51 and one frame-shaped second electrode portion 52, but the present disclosure is not limited to this example. In the mounting substrate 3, for example, the number, arrangement, shape, and the like of the first electrode portion 51 and the second electrode portion 52 may be appropriately changed.

Next, the vibration model and the zero-point bias output of the resonator 2 will be described.

When viewed from a normal direction with respect to a planar direction formed by the mounting substrate 3 (hereinafter referred to as “top view”), the resonator 2 is brought into a resonance state in which the number of antinodes and nodes in a vibration amplitude of the outline of the rim 23 is 2n as illustrated in FIG. 4, for example, by voltage application to some of the first electrode portions 51. The reference sign “n” is an integer of two or more, and such a resonance state of the resonator 2 is referred to as a “wineglass mode”. FIG. 4 illustrates, as a representative example, a state in which vibration axes x and y to be described later coincide with electrode axes X and Y in the resonance mode of n=2 in the wineglass mode, but the resonator 2 can be vibrated even in a high-order wineglass mode of n=3 or more.

Hereinafter, for convenience of description, as illustrated in FIG. 4, with a center position of the rim 23 in top view as a center C, a radial direction around a straight line passing through the center C along a thickness direction of the mounting substrate 3 is referred to as a “substrate radial direction”, and a circumferential direction around the straight line is referred to as a “substrate circumferential direction”. Of the directions along the substrate radial direction, a direction passing through the position of an antinode of vibration in the rim 23 of the resonator 2 in the first vibration mode (resonance angle frequency ω₁) is referred to as a “vibration axis x”, and a direction passing through the position of a node is referred to as a “vibration axis y”. In the wineglass mode with n=k (k: an integer of two or more), an angle between the vibration axis x and the vibration axis y is (360/4 k)°. For example, in the wineglass mode with n=2, the angle between the vibration axis x and the vibration axis y is 45°.

For example, the plurality of first electrode portions 51 are arranged apart from each other along the substrate circumferential direction, and are arranged such that distances from the rim 23 in a non-vibrating state are substantially the same. For convenience of description, for example, as illustrated in FIG. 4, one direction on an actual plane on which the plurality of first electrode portions 51 is arranged is referred to as an “Xᵣ direction”, a direction orthogonal to the Xᵣ direction on the plane is referred to as a “Yᵣ direction”, and the plane is referred to as an “XᵣYᵣ plane”. One direction in the XᵣYᵣ plane is defined as an “electrode axis X”, and a direction oriented when the electrode axis X is rotated counterclockwise (360/4 k) ° along the substrate circumferential direction on the XᵣYᵣ plane is defined as an “electrode axis Y”.

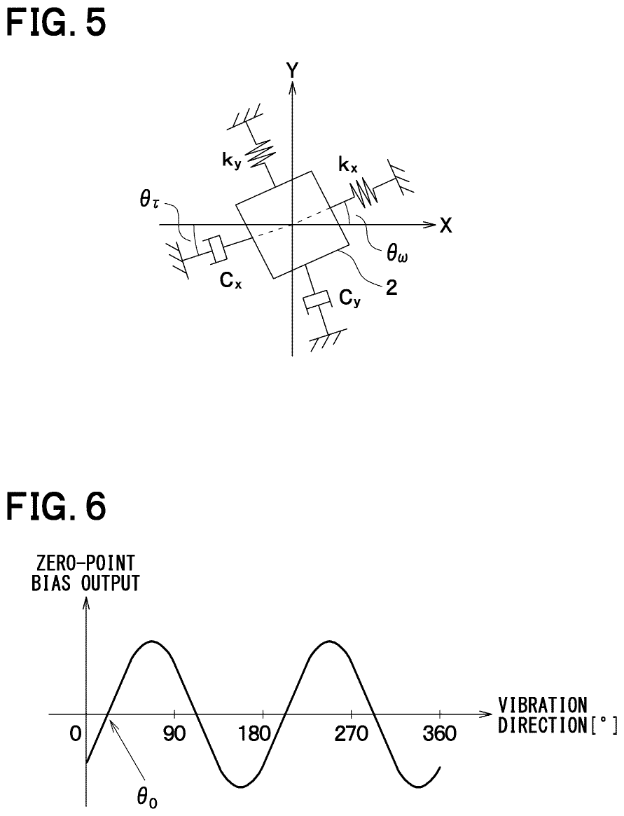

As illustrated in FIG. 5, for example, the resonator 2 can be regarded as a vibrating body of a two-degree-of-freedom system in which two springs having spring constants kₓ and k_{y} along the vibration direction and two objects having damping coefficients Cₓ and C_{y} are connected and which vibrates on a two-dimensional plane in top view. FIG. 5 illustrates that the vibration axes x and y and the electrode axes X and Y on the XᵣYᵣ plane are converted into an orthogonal coordinate system, and the origin of the vibration axes x and y and the origin of the electrode axes X and Y coincide with each other. Hereinafter, the vibration axes x and y may be simply referred to as an x axis and a y axis.

The two-dimensional plane here means a plane along a surface of the mounting substrate 3 on which the plurality of first electrode portions 51 is formed. The spring constants kₓ and k_{y} are spring constants at the vibration axes x and y, respectively, and the damping coefficients Cₓ and C_{y} are damping coefficients of vibration at the vibration axes x and y, respectively. The angle θ_{ω} is an angle formed by the electrode axes X and Y and the vibration axes x and y which are spring axes, and the angle θ_{T} is an angle formed by the electrode axes X and Y and a damper axis along a direction in which the vibration is attenuated. The sensor element including the resonator 2 and the mounting substrate 3 normally satisfies θ_{ω}≠0 unless special processing or the like is performed.

Here, an equation of motion of the vibration model of the two-degree-of-freedom system illustrated in FIG. 5 is expressed by the following equation (2).

$$[ \begin{matrix}\ddot{x} \\ \ddot{y}\end{matrix} ] + [ \begin{matrix}\frac{2}{τ} + Δ ( \frac{1}{τ} ) cos 2 {θ}_{τ} & Δ ( \frac{1}{τ} ) sin 2 {θ}_{τ} - 2 η Ω \\ Δ ( \frac{1}{τ} ) sin 2 {θ}_{τ} + 2 η Ω & \frac{2}{τ} - Δ ( \frac{1}{τ} ) cos 2 {θ}_{τ}\end{matrix} ] [ \begin{matrix}\dot{x} \\ \dot{y}\end{matrix} ] + [ \begin{matrix}{ω}^{2} - ωΔω cos 2 {θ}_{ω} & - ω Δω sin 2 {θ}_{ω} \\ - ω Δω sin 2 {θ}_{ω} & {ω}^{2} + ωΔω cos 2 {θ}_{ω}\end{matrix} ] [ \begin{matrix}x \\ y\end{matrix} ] = \frac{1}{M} [ \begin{matrix}{F}_{x} \\ {F}_{y}\end{matrix} ] \qquad ( 2 )$$

In the equation (2), ω is a resonance angle frequency of the resonator 2, and Δω is an absolute value of a difference between the resonance angle frequencies of the first vibration mode and the second vibration mode when the resonance angle frequencies are set to ω₁ and ω₂. As described above, the zero-point bias output is expressed by the equation (1), which is obtained by the equation (2). The zero-point bias output depends on Δ(1/T), which is a Q value difference between the vibration axes x, and y and θ_{T}. Note that Δ(1/T) and T are expressed by the following equations (3) and (4).

$$Δ ( 1 / ⊤ ) = ( 1 / {⊤}_{x} ) - ( 1 / {⊤}_{y} ) \qquad ( 3 )$$

Tₓ and T_{y} in the equation (3) are time constants on the x axis and the y axis.

In the equation (4), ƒ is a damping ratio, and ωₙ is a natural angular frequency.

The zero-point bias output has a sinusoidal waveform as illustrated in FIG. 6, for example, when a vibration azimuth of the resonator 2 is the horizontal axis and the vertical axis is the zero-point bias output on the basis of the equation (1). That is, assuming that θ_{T} is a vibration azimuth at which the zero-point bias output becomes zero, the zero-point bias output is minimized by adjusting θ_{T} to be θ₀. The gyro sensor 1 corrects gain ratios of the x and y axes of a detection signal from a sensor unit including the resonator 2 and the mounting substrate 3 and a gain ratio of the x and y axes of a drive signal to the sensor unit, and then controls the vibration azimuth as described above to minimize the zero-point bias output. The details will be described later. Note that the sensor unit means a part including the sensor element including the resonator 2 and the mounting substrate 3 and a circuit (not illustrated) such as a current-voltage conversion circuit used for applying a voltage to the plurality of first electrode portions 51.

Next, the control unit 10 of the gyro sensor 1 will be described.

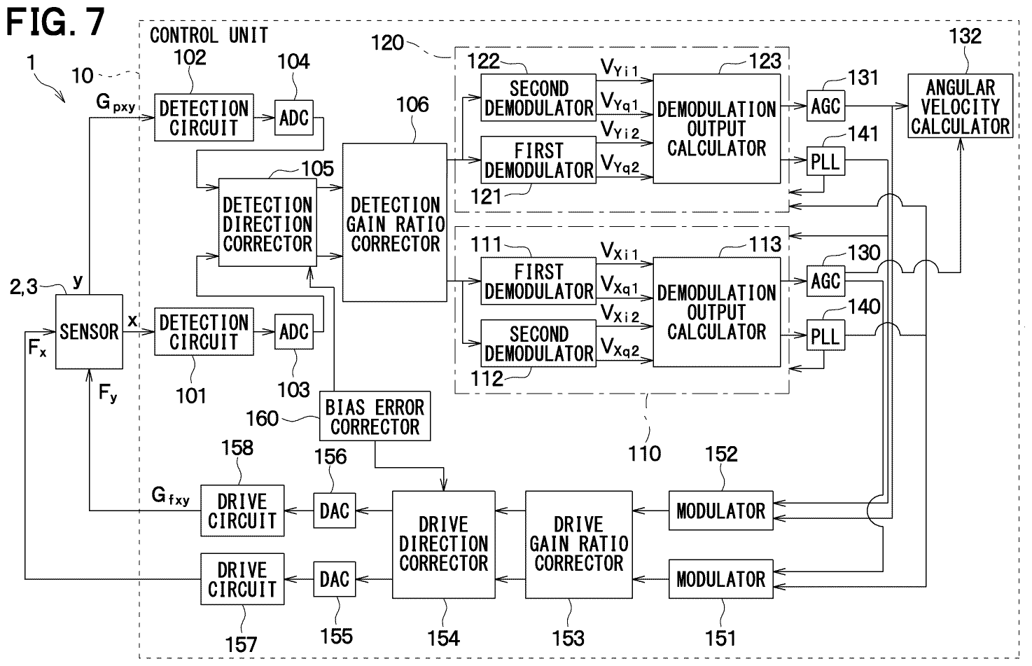

For example, as illustrated in FIG. 7, the control unit 10 includes detection circuits 101 and 102 that detect vibration of the x axis and the y axis of the resonator 2, and ADCs 103 and 104 that convert analog signals of the detection circuits 101 and 102 into digital signals. The ADC is an abbreviation for an analog to digital converter. For example, the detection circuit 101 detects a signal from a detection electrode that detects vibration of the x axis among the plurality of first electrode portions 51. The detection circuit 102 detects a signal from a detection electrode that detects vibration of the vibration axis y among the plurality of first electrode portions 51. The ADC 103 converts an analog signal from the detection circuit 101 into a digital signal. The ADC 104 converts an analog signal from the detection circuit 102 into a digital signal.

The control unit 10 includes, for example, a detection direction corrector 105 to which signals from the ADCs 103 and 104 are input, a detection gain ratio corrector 106, a first demodulation block 110, and a second demodulation block 120.

For example, the detection direction corrector 105 corrects a detection direction of vibration of the x axis and the y axis on the basis of an input signal from a bias error corrector 160 to be described later. After the detection gain ratio and a drive gain ratio are corrected, the detection direction corrector 105 executes processing of correcting the vibration detection direction to the vibration azimuth θ₀ at which the zero-point bias output is minimized.

For example, the detection gain ratio corrector 106 corrects the gain ratio of the detection signals of the x axis and the y axis, that is, the detection gain ratio based on information from the demodulation blocks 110 and 120 when AGCs 130 and 131 and PLLs 140 and 141 are operated. The detection gain ratio calculated by the detection gain ratio corrector 106 or a demodulation output calculator 113 is used to calculate the vibration azimuth in which the zero-point bias output is minimized. The calculation of the detection gain ratio will be described later.

For example, the first demodulation block 110 calculates a demodulation output related to the vibration axis x on the basis of the input signal from the detection gain ratio corrector 106. For example, on the basis of a frequency signal for the vibration axis x from the PLL 140 to be described later, the first demodulation block 110 outputs an amplitude component in phase with the frequency signal and an amplitude component having a phase deviated by 90° from the frequency signal. The first demodulation block 110 includes, for example, a first demodulator 111, a second demodulator 112, and a demodulation output calculator 113.

For example, the first demodulator 111 calculates demodulation outputs V_{Xi1} and V_{Xq1} on the basis of a first drive signal and a processing signal V_{Xβ} for driving the resonator 2 in the first vibration mode at the resonance angle frequency ω₁. The demodulation outputs V_{Xi1} and V_{Xq1} are calculated on the basis of the detection signal from the detection electrode on the x axis, and are a demodulation output in phase with the drive signal having the resonance angle frequency ω₁ of the first vibration mode and a demodulation output in quadrature with the drive signal. For example, the second demodulator 112 calculates demodulation outputs V_{Xi2} and V_{Xq2} on the basis of a second drive signal and the processing signal V_{Xβ} for driving the resonator 2 in the second vibration mode at the resonance angle frequency ω₂. In the system in which the resonant drive of the resonance angle frequencies ω₁ and ω₂ of the resonator 2 is maintained by the two independent PLLs 140 and 141, this calculation is possible because the processing signal V_{Xβ} includes information regarding a vibration amplitude in the direction of the vibration axis y of the second vibration mode. The demodulation outputs V_{Xi2} and V_{Xq2} are calculated on the basis of the detection signal from the detection electrode on the x axis, and are a demodulation output in phase with the drive signal having the resonance angle frequency ω₂ of the second vibration mode and a demodulation output in quadrature with the drive signal. The demodulation output calculator 113 calculates an amplitude and a phase of the first vibration mode of the resonator 2 on the basis of V_{Xi1}, V_{Xq1}, V_{Xi2}, and V_{Xq2}, for example.

For example, the second demodulation block 120 calculates a demodulation output related to the vibration axis y on the basis of the input signal from the detection gain ratio corrector 106. For example, on the basis of a frequency signal for the vibration axis y from the PLL 141 to be described later, the second demodulation block 120 outputs an amplitude component in phase with the frequency signal and an amplitude component having a phase deviated by 90° from the frequency signal. The second demodulation block 120 includes, for example, a first demodulator 121, a second demodulator 122, and a demodulation output calculator 123.

For example, the first demodulator 121 calculates demodulation outputs V_{Yi2} and V_{Yq2} on the basis of the second drive signal and a processing signal V_{Yβ}. The demodulation outputs V_{Yi2} and V_{Yq2} are calculated on the basis of the detection signal from the detection electrode on the y axis, for example, and are a demodulation output in phase with the frequency signal having the resonance angle frequency ω₂ of the second vibration mode and a demodulation output in quadrature with the drive signal. For example, the second demodulator 122 calculates demodulation outputs V_{Yi1} and V_{Yq1} on the basis of the first drive signal and the processing signal V_{Yβ}. The demodulation by the second demodulator 122 is possible because the processing signal V_{Yβ} includes information regarding a vibration amplitude in the direction of the vibration axis x of the first vibration mode, as described above. The demodulation outputs V_{Yi1} and V_{Yq1} are calculated on the basis of the detection signal from the detection electrode on the y axis, for example, and are a demodulation output in phase with the drive signal having the resonance angle frequency ω₁ of the first vibration mode and a demodulation output in quadrature with the frequency signal. The demodulation output calculator 113 calculates an amplitude and a phase of the second vibration mode of the resonator 2 on the basis of V_{Yi1}, V_{Yq1}, V_{Yi2}, and V_{Yq2}, for example. Note that the calculation of each demodulation output described above will be described later.

The control unit 10 includes the AGC 130 and the PLL 140 for resonantly driving the resonator 2 in the first vibration mode and maintaining the same, and the AGC 131 and the PLL 141 for resonantly driving the resonator 2 in the second vibration mode and maintaining the same. The AGC is an abbreviation for automatic gain control, and is also referred to as control for automatic gain. The PLL is an abbreviation for phase locked loop.

For example, amplitude information in the direction of the vibration axis x of the first vibration mode of the resonator 2 is input from the first demodulation block 110, and the AGC 130 performs calculation and signal output for controlling the amplitude in the first vibration mode to a predetermined constant value on the basis of the amplitude information. For example, the AGC 130 outputs a control signal for amplitude fixation to a modulator 151, and outputs a signal for angular velocity calculation to an angular velocity calculator 132.

For example, amplitude information in the direction of the vibration axis y of the second vibration mode of the resonator 2 is input from the second demodulation block 120, and the AGC 131 performs calculation and signal output for controlling the amplitude in the second vibration mode to a predetermined constant value on the basis of the amplitude information. For example, the AGC 131 outputs a control signal for amplitude fixation to a modulator 152, and outputs a signal for angular velocity calculation to the angular velocity calculator 132.

For example, on the basis of the input signals V_{Ω+} and V_{Ω-} from the AGCs 130 and 131, the angular velocity calculator 132 calculates the angular velocity applied from the outside to the gyro sensor 1 by dividing a value obtained by subtracting these signals by a scale factor measured in advance. In addition, for example, when determining the vibration azimuth for minimizing the zero-point bias output, the angular velocity calculator 132 calculates the angular velocity for each angle input of the bias error corrector 160 to be described later.

For example, phase information regarding the first vibration mode of the resonator 2 is input from the first demodulation block 110 to the PLL 140, and the PLL 140 performs frequency control and signal output of the first drive signal for driving the resonator 2 in the first vibration mode of the resonance angle frequency ω₁. The PLL 140 includes, for example, a PI circuit and an NCO circuit (not illustrated). The PI circuit corrects a signal of the demodulation output V_{Xq1}, and the NCO circuit outputs the first drive signal having a predetermined frequency on the basis of the corrected signal. The PI is an abbreviation for proportional integral. The NCO is an abbreviation for a numerically controlled oscillator, and generates a signal of a frequency such as a sin wave or a cos wave. The PLL 140 outputs a signal to the demodulation blocks 110 and 120 and the modulator 151.

For example, phase information regarding the second vibration mode of the resonator 2 is input from the second demodulation block 120 to the PLL 141, and the PLL 141 performs frequency control and signal output of the second drive signal for driving the resonator 2 the resonance angle frequency ω₂. The PLL 141 has a similar configuration to the configuration of the PLL 140. The PI circuit corrects a signal of the demodulation output V_{Yq2}, and the NCO circuit outputs the second drive signal having a predetermined frequency on the basis of the corrected signal. The PLL 141 outputs a signal to the demodulation blocks 110 and 120 and the modulator 152.

The control unit 10 includes, for example, the modulator 151 to which output signals from the AGC 130 and the PLL 140 are input, and the modulator 152 to which output signals from the AGC 131 and the PLL 141 are input.

For example, the modulator 151 superimposes the frequency signal from the PLL 140 on an amplitude control signal input from the AGC 130, and outputs the superimposed signal to the drive gain ratio corrector 153. For example, the modulator 152 superimposes the frequency signal from the PLL 141 on an amplitude control signal input from the AGC 131, and outputs the superimposed signal to the drive gain ratio corrector 153.

The control unit 10 includes, for example, the drive gain ratio corrector 153, a drive direction corrector 154, DACs 155 and 156, and drive circuits 157 and 158.

The drive gain ratio corrector 153 calculates a gain ratio of the drive signals of the x axis and the y axis, that is, a drive gain ratio, on the basis of the input signals from the modulators 151 and 152 when the AGCs 130 and 131 and the PLLs 140 and 141 are operated. The drive gain ratio calculated by the drive gain ratio corrector 153 is used together with the detection gain ratio to calculate the vibration azimuth in which the zero-point bias output is minimized. The calculation of the drive gain ratio will be described later.

The drive direction corrector 154 corrects the vibration directions of the x axis and the y axis on the basis of the input signal from the bias error corrector 160, for example. The drive direction corrector 154 executes processing of correcting the drive directions to the vibration azimuth θ₀ calculated after correction of the detection gain ratio and the drive gain ratio.

For example, the DACs 155 and 156 convert digital signals for drive control of the resonator 2 input from the drive direction corrector 154 into analog signals, and output the analog signals to the drive circuits 157 and 158, respectively. The DAC is an abbreviation for a digital to analog converter.

For example, the drive circuits 157 and 158 output drive signals for the x axis and the y axis to the drive electrodes of the plurality of first electrode portions 51 in order to vibrate the resonator 2 in the resonance mode. As a result, a force Fₓ by the electrostatic force and a force F_{y} by the electrostatic force respectively act on the x axis and the y axis on the resonator 2, and vibration control is performed.

For example, after correcting the detection gain ratio and the drive gain ratio, the bias error corrector 160 calculates the vibration azimuth θ₀ in which the zero-point bias output is minimized, and outputs a command signal corresponding to the calculated vibration azimuth θ₀ to the detection direction corrector 105 and the drive direction corrector 154. The calculation of the vibration azimuth θ₀ by the bias error corrector 160 will be described later.

The basic configuration of the control unit 10 has been described above. Note that the control unit 10 is not limited to the example illustrated in FIG. 7, and the configuration of the control unit 10 may be appropriately changed as long as the control unit 10 can perform control to minimize the zero-point bias output.

For example, the control unit 10 may be configured such that the positions of the detection direction corrector 105 and the detection gain ratio corrector 106 are opposite, that is, the detection gain ratio is calculated before the calculation of the detection direction correction. For example, the control unit 10 may be configured such that the positions of the drive direction corrector 154 and the drive gain ratio corrector 153 are opposite, that is, the drive gain ratio is calculated after the calculation of the drive direction correction. For example, the control unit 10 may be configured to perform a gyro operation in an open-loop operation in which the information of the y direction input to the second demodulation block 120 is not fed back. In this case, for example, the control unit 10 is configured such that the signals from the demodulation blocks 110 and 120 are directly input to the angular velocity calculator 132. For example, the control unit 10 may be configured to perform FtR control of feeding back the information of the y direction input to the second demodulation block 120 to control the amplitude in the y direction to 0, and calculating the angular velocity from the control voltage at this time. Note that FtR is an abbreviation for force to rebalance. In this manner, the control unit 10 can appropriately change some of the constituent elements.

### (Calculation in Demodulation Block)

Next, calculation of the demodulation output in the demodulation blocks 110 and 120 will be described.

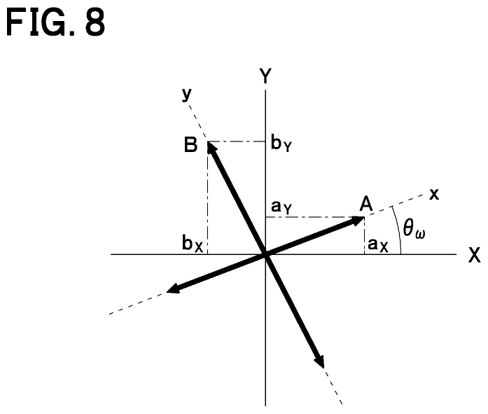

In a case where the first vibration mode and the second vibration mode of the resonance mode of n=2 are both driven to resonate, the resonator 2 vibrates along two orthogonal vibration axes x and y, for example, as illustrated in FIG. 8. The vibration amplitude and the resonance angle frequency on the vibration axis x are A and ω₁, respectively, the vibration amplitude and the resonance angle frequency on the vibration axis y are B and ω₂, respectively, and the angle between the vibration axis x and the electrode axis X is θ_{ω}. At this time, the vibration amplitudes of the vibration axes x and y at a time t are expressed by the following equations (5) and (6).

$$x = A sin ( {ω}_{1} t + {φ}_{1} ) \qquad ( 5 )$$

$$y = B sin ( {ω}_{2} t + {φ}_{2} ) \qquad ( 6 )$$

φ₁ in the equation (5) and φ₂ in the equation (6) are phases for an external force applied from each direction. Assuming that the respective components of the vibration of the amplitude A on the electrode axes X and Y are a_{X} and a_{Y}, and the respective components of the vibration of the amplitude B on the electrode axes X and Y are b_{X} and b_{Y}, θ_{ω}, which is the deviation angle between the vibration axis x and the electrode axis X, is expressed by the following equation (7) from the orthogonality of the vibration axes x and y.

$$\vert \frac{{a}_{X}}{{a}_{Y}} \vert = \vert \frac{{b}_{X}}{{b}_{Y}} \vert = tan ( \vert {θ}_{ω} \vert ) \qquad ( 7 )$$

The conversion between the electrode axes X and Y and the vibration axes x and y is expressed by the following equation (8).

$$( \begin{matrix}X \\ Y\end{matrix} ) = ( \begin{matrix}cos {θ}_{ω} & sin {θ}_{ω} \\ - sin {θ}_{ω} & cos {θ}_{ω}\end{matrix} ) ( \begin{matrix}x \\ y\end{matrix} ) \qquad ( 8 )$$

Since the electrode axis X is a sum of X components of the two vibration modes and the electrode axis Y is a sum of Y components of the two vibration modes, the vibration amplitudes of the electrode axes X and Y at the time t are expressed by the following equations (9) and (10).

$$X = {a}_{X} sin ( {ω}_{1} t + {φ}_{1} ) + {b}_{X} sin ( {ω}_{2} t + {φ}_{2} ) \qquad ( 9 )$$

$$Y = {a}_{Y} sin ( {ω}_{1} t + {φ}_{1} ) + {b}_{Y} sin ( {ω}_{2} t + {φ}_{2} ) \qquad ( 10 )$$

Note that the components a_{X}, b_{X}, a_{Y}, and b_{Y} in the equations (9) and (10) are a_{X}=A cos θ_{ω}, b_{X}=−B sin θ_{ω}, a_{Y}=A sin θ_{ω}, and b_{Y}=B cos θ_{ω}, respectively, in the example illustrated in FIG. 8. In addition, assuming that conversion coefficients from the amplitude to the voltage according to a detection method are ξ_{X} and ξ_{Y}, the voltages V_{XP} and V_{YP} at the detection electrodes of the electrode axes X and Y are expressed by the following equations (11) and (12).

$${V}_{XP} = {ξ}_{X} \{ {a}_{X} sin ( {ω}_{1} t + {φ}_{1} ) + {b}_{X} sin ( {ω}_{2} t + {φ}_{2} ) \} \qquad ( 11 )$$

$${V}_{YP} = {ξ}_{Y} \{ {a}_{Y} sin ( {ω}_{1} t + {φ}_{1} ) + {b}_{Y} sin ( {ω}_{2} t + {φ}_{2} ) \} \qquad ( 12 )$$

The first demodulator 111 calculates the demodulation outputs V_{Xi1} and V_{Xq1} for the external force on the vibration axes x and y on the basis of the voltage V_{XP} of the equation (11). The demodulation output V_{Xi1} is calculated by performing a process of multiplying the voltage V_{XP} by sin ω₁t as expressed by the following formula (13) and passing through a low-pass filter as expressed by the formula (14) to eliminate the term of the double wave and the frequency sum.

$${V}_{X P} sin {ω}_{1} t = {ξ}_{X} \{ {a}_{X} sin ( {ω}_{1} t + {ϕ}_{1} ) + {b}_{X} sin ( {ω}_{2} t + {ϕ}_{2} ) \} sin {ω}_{1} t = \frac{{ξ}_{X}}{2} \{ {a}_{X} cos ϕ ( 1 - cos 2 {ω}_{1} t ) + {a}_{X} sin {ϕ}_{1} sin 2 {ω}_{1} t + {b}_{X} cos {ϕ}_{2} ( - cos ( {ω}_{1} + {ω}_{2} ) t + cos Δω t ) + {b}_{X} sin {ϕ}_{2} ( sin ( {ω}_{1} + {ω}_{2} ) t - sin Δω t ) \} \qquad ( 13 )$$

$$\begin{matrix}{V}_{X i 1} = {\vert 2 {V}_{X P} sin {ω}_{1} t \vert}_{L P F} \\ = {ξ}_{X} \{ {a}_{X} cos {ϕ}_{1} + {b}_{X} ( cos {ϕ}_{2} cos Δω t - sin {ϕ}_{2} sin Δω t ) \} \\ = {ξ}_{X} \{ {a}_{X} cos {ϕ}_{1} + {b}_{X} cos ( Δω t + {ϕ}_{2} ) \}\end{matrix} \qquad ( 14 )$$

|f(t)|_{LPF} in the equation (14) means a calculation for erasing a term of a second harmonic and a frequency sum passing through the low-pass filter. The same applies to the following equations (16), (18), and (20).

The demodulation output V_{Xq1} is calculated by performing processing of multiplying the voltage V_{XP} by cos ω₁t as expressed by the following equation (15) and performing calculation of erasing unnecessary terms through the low-pass filter as expressed by the equation (16).

$${V}_{X P} cos {ω}_{1} t = {ξ}_{X} \{ {a}_{X} sin ( {ω}_{1} t + {ϕ}_{1} ) + {b}_{X} sin ( {ω}_{2} t + {ϕ}_{2} ) \} cos {ω}_{1} t = \frac{{ξ}_{X}}{2} \{ {a}_{X} cos {ϕ}_{1} sin 2 {ω}_{1} t + {a}_{X} sin {ϕ}_{1} ( 1 + cos 2 {ω}_{1} t ) + {b}_{X} cos {ϕ}_{2} ( sin ( {ω}_{1} + {ω}_{2} ) t + sin Δω t ) + {b}_{X} sin {ϕ}_{2} ( cos ( {ω}_{1} + {ω}_{2} ) t + cos Δω t ) \} \qquad ( 15 )$$

$$\begin{matrix}{V}_{Xq 1} = {\vert 2 {V}_{X P} cos {ω}_{1} t \vert}_{L P F} \\ = {ξ}_{X} \{ {a}_{X} sin {ϕ}_{1} + {b}_{X} ( cos {ϕ}_{2} sin Δω t + sin {ϕ}_{2} cos Δω t ) \} \\ = {ξ}_{X} \{ {a}_{X} sin {ϕ}_{1} + {b}_{X} sin ( Δω t + {ϕ}_{2} ) \}\end{matrix} \qquad ( 16 )$$

The second demodulator 112 calculates the demodulation outputs V_{Xi2} and V_{Xq2} for the external force on the vibration axes x and y on the basis of the voltage V_{XP} of the equation (11). The second demodulator 112 acquires a frequency signal for driving the resonator 2 in the second vibration mode of the resonance angle frequency ω₂ from the PLL 141, for example, and calculates the demodulation outputs V_{Xi2} and V_{Xq2}. The demodulation output V_{Xi2} is calculated by performing processing of multiplying the voltage V_{XP} by sin(ω₂t+Δφ) as expressed by the following equation (17) and performing calculation of erasing unnecessary terms through the low-pass filter as expressed by the equation (18). Note that Δφ is a phase of an output signal of the oscillation circuit (not illustrated) in the PLL 140 when the output signal of the oscillation circuit (not illustrated) in the PLL 140 is used as a reference.

$${V}_{XP} sin ( {ω}_{2} t + Δφ ) = {ξ}_{X} \{ {a}_{X} sin ( {ω}_{1} t + {φ}_{1} ) + {b}_{X} sin ( {ω}_{2} t + {φ}_{2} ) \} sin ( {ω}_{2} t + Δφ ) \qquad ( 17 )$$

$$\begin{matrix}{V}_{X i 2} = {\vert 2 {V}_{X P} sin ( {ω}_{2} t + Δϕ ) \vert}_{L P F} \\ = {ξ}_{X} \{ {b}_{X} cos ( {ϕ}_{2} - Δϕ ) + {a}_{X} cos ( Δω t - {ϕ}_{1} + Δϕ ) \}\end{matrix} \qquad ( 18 )$$

The demodulation output V_{Xq2} is calculated by performing processing of multiplying the voltage V_{XP} by cos (ω₂t+Δφ) as expressed by the following equation (19) and performing calculation of erasing unnecessary terms through the low-pass filter as expressed by the equation (20).

$${V}_{XP} cos ( {ω}_{2} t + Δφ ) = {ξ}_{X} \{ {a}_{X} sin ( {ω}_{1} t + {φ}_{1} ) + {b}_{X} sin ( {ω}_{2} t + {φ}_{2} ) \} cos ( {ω}_{2} t + Δφ ) \qquad ( 19 )$$

$$\begin{matrix}{V}_{Xq 2} = {\vert 2 {V}_{X P} cos ( {ω}_{2} t + Δϕ ) \vert}_{L P F} \\ = {ξ}_{X} \{ {b}_{X} sin ( {ϕ}_{2} - Δϕ ) + {a}_{X} sin ( Δω t - {ϕ}_{1} + Δϕ ) \}\end{matrix} \qquad ( 20 )$$

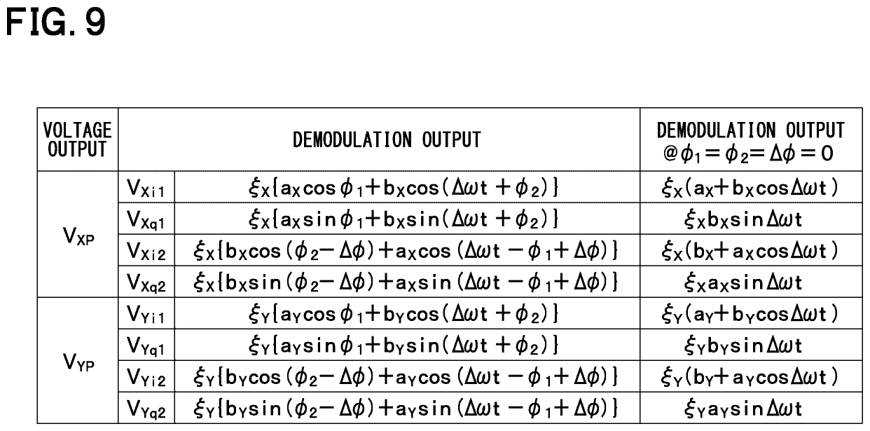

The first demodulator 121 calculates the demodulation outputs V_{Yi2} and V_{Yq2} for the external force on the vibration axes x and y on the basis of the detection voltage V_{YP} of the equation (12). The second demodulator 122 acquires a frequency signal for driving the resonator 2 in the second vibration mode of the resonance angle frequency ω₁ from the PLL 140, for example, and calculates the demodulation outputs V_{Yi1} and V_{Yq1}. The demodulation outputs V_{Yi1}, V_{Yq1}, V_{Yi2}, and V_{Yq2} based on the detection voltage V_{YP} are calculated by calculation processing similar to V_{Xi1}, V_{Xq1}, V_{Xi2}, and V_{Xq2} described above, and are expressed by the equations illustrated in FIG. 9. In a case where φ₁=φ₂=Δφ=0, these demodulation outputs can be transformed into mathematical expressions without terms of φ₁, φ₂, and Δφ.

The demodulation outputs V_{Xi1}, V_{Xq1}, V_{Xi2}, V_{Xq2}, V_{Yi1}, V_{Yq1}, V_{Yi2}, and V_{Yq2} are output to, for example, the demodulation output calculators 113 and 123 and the like and are used for calculating the amplitudes and the phase differences of the first vibration mode and the second vibration mode. Hereinafter, for convenience of description, the demodulation outputs V_{Xi1}, V_{Xq1}, V_{Xi2}, V_{Xq2}, V_{Yi1}, V_{Yq1}, V_{Yi2}, and V_{Yq2} are collectively referred to as “each of the demodulation outputs”.

For example, the demodulation output calculators 113 and 123 include a high-pass filter (hereinafter referred to as “HPF”), a calculator that performs calculation using each of the demodulation outputs after passing through the HPF, and a phase comparison unit that calculates a phase difference of each of the demodulation outputs.

For example, the demodulation output calculator 113 calculates |ξ_{X}b_{X}| by calculating a sum of squares by adding the results obtained by squaring the demodulation outputs V_{Xi1} and V_{Xq1} after passing through the HPF by the calculator. For example, the demodulation output calculator 113 calculates |ξ_{X}a_{X}| by calculating a sum of squares in the calculator based on the demodulation outputs V_{Xi2} and V_{Xq2} after passing through the HPF. In addition, the demodulation output calculator 113 calculates a phase difference Δφ_{Xi} on the basis of the demodulation outputs V_{Xi1} and V_{Xi2} after passing through the HPF, and calculates a phase difference Δφ_{Xq} on the basis of the demodulation outputs V_{Xq1} and V_{Xq2} after passing through the HPF, for example.

For example, the demodulation output calculator 123 calculates |ξ_{Y}b_{Y}| by the calculation of a sum of squares based on the demodulation outputs V_{Yi1} and V_{Yq1} and calculates |ξ_{Y}a_{Y}| by the calculation of a sum of squares based on the demodulation outputs V_{Yi2} and V_{Yq2} by similar processing to the processing of the demodulation output calculator 113. For example, similarly to the demodulation output calculator 113, the demodulation output calculator 123 calculates a phase difference Δφ_{Yi} on the basis of the demodulation outputs V_{Yi1} and V_{Yi2}, and calculates a phase difference Δφ_{Yq} on the basis of V_{Yq1} and V_{Yq2}.

For example, the demodulation blocks 110 and 120 can acquire the amplitude information of the resonance mode by the above calculation of |ξ_{X}a_{X}|, |ξ_{Y}a_{Y}|, |ξ_{X}b_{X}|, and |ξ_{Y}b_{Y}|, and can acquire the phase information of the resonance mode by the above calculation of the phase differences Δφ_{Xi}, Δφ_{Xq}, Δφ_{Yi}, and Δφ_{Yq}. Hereinafter, for convenience of description, the calculation of |ξ_{X}a_{X}|, |ξ_{X}a_{X}|, |ξ_{X}b_{X}|, and |ξ_{Y}b_{Y}| for calculating the amplitude are simply referred to as “amplitude calculation”.

Next, the detection gain ratio and the drive gain ratio will be described.

In the system in which a driving force is input to the resonator 2 as illustrated in FIG. 7, a case where a non-ideal gain ratio between the x axis and the y axis exists as G_{pxy} will be considered. Hereinafter, this non-ideal gain ratio is referred to as a detection gain ratio G_{pxy}. In this case, assuming that voltages input to the axes are voltages Vₓ and V_{y}, x and y of vibration information of the resonator 2 are expressed by the following equation (21) by the voltages Vₓ and V_{y} and the detection gain ratio G_{pxy}.

$$[ \begin{matrix}{V}_{x} \\ {V}_{y}\end{matrix} ] = [ \begin{matrix}1 & 0 \\ 0 & {G}_{pxy}\end{matrix} ] [ \begin{matrix}x \\ y\end{matrix} ] = [ \begin{matrix}x \\ {G}_{p x y} \cdot y\end{matrix} ] \qquad ( 21 )$$

In order to cancel the non-ideal detection gain ratio G_{pxy} in the equation (21), the detection gain ratio G_{pxy} only needs to be calculated by some means, and the equation (21) only needs to be multiplied by a determinant of the following equation (22).

$$[ \begin{matrix}1 & 0 \\ 0 & 1 / {G}_{pxy}\end{matrix} ] \qquad ( 22 )$$

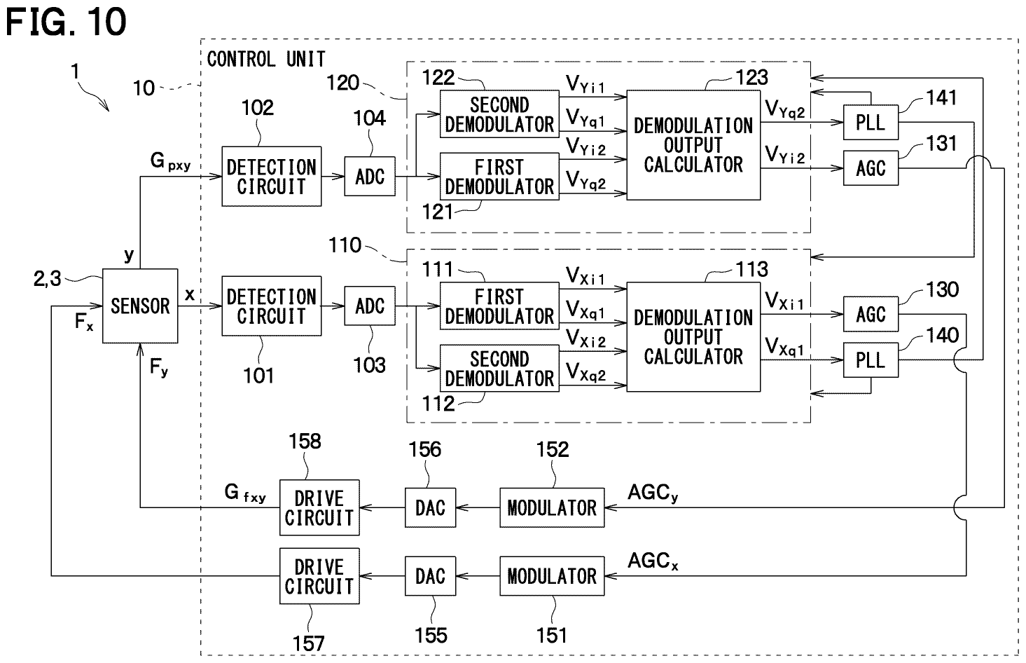

For example, the detection gain ratio corrector 106 performs a matrix calculation of multiplying the determinant of the equation (22), that is, a matrix including 1/G_{pxy} that is a reciprocal of the detection gain ratio by the determinant of the detection signal obtained through the detection circuits 101 and 102 indicated in the equation (21). When calculating the detection gain ratio and the drive gain ratio, for example, as illustrated in FIG. 10, the control unit 10 performs gain ratio calculation processing in a calculation mode in which processing is not performed in some of the constituent elements illustrated in FIG. 7. Note that, in FIG. 10, some of the constituent elements not used for the angular velocity calculation and the gain ratio calculation are omitted for ease of viewing.

In the calculation mode of each gain ratio, the control unit 10 inputs detection signals of vibration in the x and y axes from the sensor unit to the demodulation blocks 110 and 120 through the detection circuits 101 and 102 and the ADCs 103 and 104, and performs each of the demodulation outputs and amplitude calculation based on each of the demodulation outputs. The demodulation outputs V_{Xq1} and V_{Yq2} are used for calculating the detection gain ratio G_{pxy}. The detection gain ratio G_{pxy} calculated in a gain ratio calculation mode is, for example, held in a recording medium (not illustrated) in the control unit 10, and then read from the recording medium and used in an angular velocity calculation mode for calculating an angular velocity. The same applies to a drive gain ratio G_{txy} to be described later.

The calculation of the detection gain ratio G_{pxy} is performed in a state where no angular velocity input is applied to the sensor unit, that is, in an off-line state. The detection gain ratio G_{pxy} is expressed by the following equation (23).

$${G}_{p x y} = \frac{{k}_{x}}{{k}_{y}} = \sqrt{\frac{{D}_{x}}{{D}_{y}}} \qquad ( 23 )$$

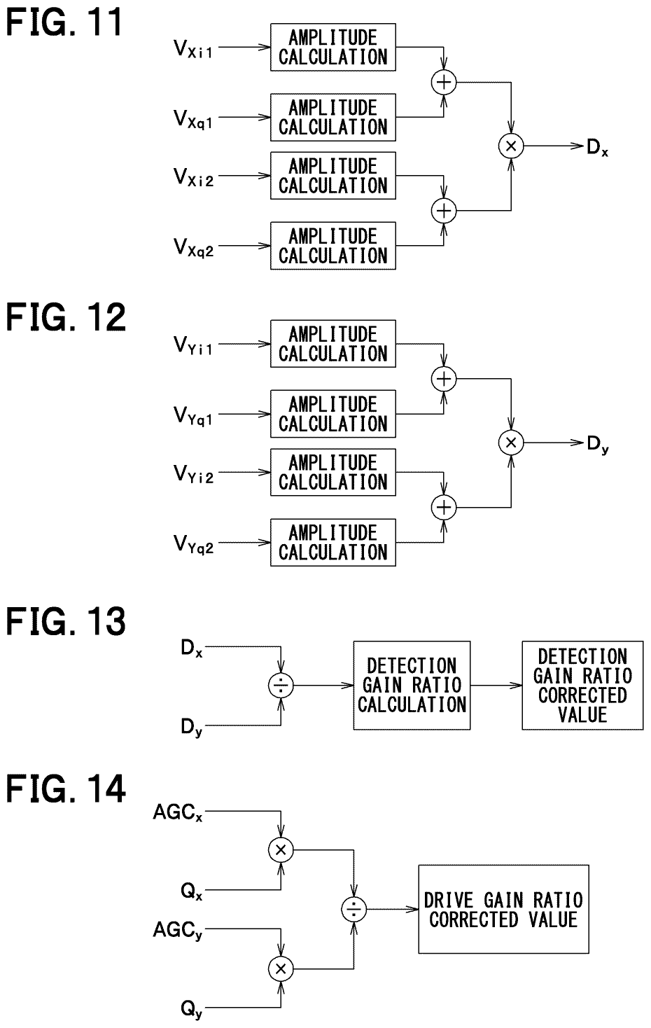

Dₓ and D_{y} in the equation (23) are calculation values calculated by the calculations illustrated in FIGS. 11 and 12, for example. Specifically, for example, as illustrated in FIG. 11, the first demodulation block 110 performs an amplitude calculation based on the demodulation output V_{Xi1} and an amplitude calculation based on the demodulation output V_{Xq1}, and calculates a first addition value obtained by adding two values obtained by each of the amplitude calculations. In addition, for example, the first demodulation block 110 performs an amplitude calculation based on the demodulation output V_{Xi2} and an amplitude calculation based on the demodulation output V_{Xq2}, and calculates a second addition value obtained by adding two values obtained by each of the amplitude calculations. Then, for example, the first demodulation block 110 calculates the calculation value Dₓ by multiplying the first addition value by the second addition value.

For example, as illustrated in FIG. 12, the second demodulation block 120 performs an amplitude calculation based on each of the demodulation outputs V_{Yi1} and V_{Yq1}, and adds the obtained two values to calculate a third addition value. Furthermore, for example, the second demodulation block 120 performs an amplitude calculation based on each of the demodulation outputs V_{Yi2} and V_{Yq2}, calculates a fourth addition value obtained by adding two values obtained by each of the amplitude calculations, and then multiplies the fourth addition value by the third addition value and the fourth addition value to calculate the calculation value D_{y}.

Then, for example, as illustrated in FIG. 13, the detection gain ratio corrector 106 performs calculation to obtain a square root of a value obtained by dividing the calculated calculation value Dₓ by the calculation value D_{y}, and calculates the detection gain ratio G_{pxy}. Then, the detection gain ratio corrector 106 calculates a detection gain ratio correction value expressed by the equation (22) based on the detection gain ratio G_{pxy}, and multiplies the equation (21) by the detection gain ratio correction value to correct the detection gain ratio.

Next, a case where a non-ideal gain ratio between the driving force Fₓ and the driving force F_{y} exists as G_{fxy} in a system in which the driving forces Fₓ and F_{y} are input to the resonator 2 will be considered. Hereinafter, the non-ideal gain ratio in the two driving forces Fₓ and F_{y} is referred to as drive gain ratio G_{txy}. Assuming that the output signal from the DAC 155 of the x axis and the output signal from the DAC 156 of the y axis are VFₓ and VF_{y}, respectively, the driving forces Fₓ and F_{y} applied to the resonator 2 on the basis of the drive signals from the drive circuits 157 and 158 are expressed by the following equation (24) including the drive gain ratio G_{txy}.

$$[ \begin{matrix}{F}_{x} \\ {F}_{y}\end{matrix} ] = [ \begin{matrix}1 & 0 \\ 0 & {G}_{fxy}\end{matrix} ] [ \begin{matrix}{V F}_{x} \\ {V F}_{y}\end{matrix} ] = [ \begin{matrix}{V F}_{x} \\ {G}_{fxy} \cdot {V F}_{y}\end{matrix} ] \qquad ( 24 )$$

In order to cancel the non-ideal drive gain ratio G_{fxy} in the equation (24), the drive gain ratio G_{fxy} only needs to be calculated by some means, and the equation (24) only needs to be multiplied by a determinant of the following equation (25).

$$[ \begin{matrix}1 & 0 \\ 0 & 1 / {G}_{fxy}\end{matrix} ] \qquad ( 25 )$$

For example, the drive gain ratio corrector 153 performs a matrix calculation of multiplying the determinant of the equation (25), that is, a matrix including 1/G_{fxy} that is a reciprocal of the drive gain ratio by the determinant of the equation (24). The calculation of the drive gain ratio G_{txy} is performed in the off-line state similarly to the calculation of the detection gain ratio G_{pxy}. The drive gain ratio G_{fxy} is expressed by the following equation (26).

$${G}_{fxy} = \frac{{F}_{x} {Q}_{x}}{{F}_{y} {Q}_{y}} \qquad ( 26 )$$

For example, as illustrated in FIG. 14, the drive gain ratio corrector 153 calculates the drive gain ratio G_{fxy} and a drive gain ratio correction value on the basis of AGCₓ, Qₓ, AGC_{y}, and Q_{y}. AGCₓ is an AGC output regarding the driving force Fₓ of the x axis output from the AGC 130 to the modulator 151, and AGC_{y} is an AGC output regarding the driving force F_{y} of the y axis output from the AGC 131 to the modulator 152. Qₓ and Q_{y} are a Q value of vibration on the x axis of the resonator 2 and a Q value of vibration on the y axis of the resonator 2, respectively, and are calculated in advance by a known method for measuring a Q value and recorded in a recording medium (not illustrated). The drive gain ratio corrector 153 calculates a first multiplication value obtained by multiplication of AGCₓ and Qₓ and a second multiplication value obtained by multiplication of AGC_{y} and Q_{y}, and calculates the drive gain ratio G_{fxy} by dividing the first multiplication value by the second multiplication value. Then, the drive gain ratio corrector 153 calculates a drive gain ratio correction value expressed by the equation (25) based on the drive gain ratio G_{fxy}, and multiplies the equation (24) by the drive gain ratio correction value to correct the drive gain ratio.

Finally, after the detection gain ratio and the drive gain ratio are corrected, the control unit 10 drives the resonator 2 in the resonance mode and causes the resonator 2 to perform the gyro operation in a stationary state where no angular velocity is applied to the gyro sensor 1. The bias error corrector 160 performs angle input in a range of 0° to 360° to the detection direction corrector 105 and the drive direction corrector 154 to rotate a gyro operation axis by 360°. At this time, the bias error corrector 160 sweeps an input angle at an arbitrary angle step and an arbitrary driving time, for example, and records the angular velocity or the drive outputs of the AGCs 130 and 131 for each input angle on a recording medium (not illustrated). The bias error corrector 160 records an angle θ at which the angular velocity becomes the value closest to zero at the input angle of 0° to 360° described above on a recording medium (not illustrated). The angle θ corresponds to the vibration azimuth θ₀ that minimizes the zero-point bias output. Then, the bias error corrector 160 sets the angle θ as a command value of angle input to the detection direction corrector 105 and the drive direction corrector 154, and outputs the angle θ to each direction corrector as a command signal of the vibration azimuth θ₀. As a result, the gyro sensor 1 is configured to perform the gyro operation in the vibration azimuth θ₀ in which the zero-point bias output is minimized.

In the present embodiment, in the gyro sensor 1, the detection gain ratio G_{pxy} and the drive gain ratio G_{txy} of the x axis and the y axis of the resonator 2 are corrected, and an error due to the gain ratio between the x axis and the y axis of the detection signal and the drive signal is reduced. In the gyro sensor 1, after the gain ratio between the detection signal and the drive signal is corrected, the angular velocity is corrected to a value closest to zero for the detection direction and the drive direction, and the zero-point bias output is minimized.

In the gyro sensor 1 according to the present embodiment, the zero-point bias output in the measurement of the angular velocity is minimized by a control method including first to fourth steps described below. The first step is to calculate and determine the detection gain ratio G_{pxy}, which is a ratio of a gain of a first detection signal from a first detection electrode that detects vibration on the x axis of the resonator 2 and a gain of a second detection signal from a second detection electrode that detects vibration on the y axis. The second step is to calculate and determine the drive gain ratio G_{fxy}, which is a ratio between the gain of the first drive signal to the first drive electrode used in the first vibration mode and the gain of the second drive signal to the second drive electrode used in the second vibration mode. In the third step, after the gain ratios G_{pxy} and G_{fxy} are determined, the angular velocity or the drive output is calculated for each input angle while the detection direction and the drive direction of the vibration of the resonator 2 are subjected to angle input and swept in the range of 0° to 360°. Then, in the third step, a value at which the angular velocity is closest to zero is determined as the command value (vibration azimuth θ₀). The fourth step is to determine the detection direction and the drive direction to be the vibration azimuth θ₀ and measure the angular velocity.

(1) In the gyro sensor 1, the detection gain ratio corrector 106 multiplies the determinant of the equation (22) by the matrix of the equation (21) including 1/G_{pxy}, which is the reciprocal of the detection gain ratio, and performs matrix calculation to cancel the non-ideal detection gain ratio G_{pxy} between the x axis and the y axis.

(2) In the gyro sensor 1, the drive gain ratio corrector 153 multiplies the determinant of the equation (25) by the matrix of the equation (24) including 1/G_{fxy}, which is the reciprocal of the drive gain ratio, and performs matrix calculation to cancel the non-ideal drive gain ratio G_{fxy} between the x axis and the y axis.

### OTHER EMBODIMENTS

Although having been described in accordance with examples, the present disclosure should not be limited to the examples and structures. The present disclosure also includes various modifications and changes within the range of equivalency. In addition, various combinations and forms, as well as other combinations and forms that include only one element, more, or less, are within the scope and range of spirit of the present disclosure.

In the sensor element, the configuration in which the resonator 2 has a substantially hemispherical shape or a substantially disk shape and the plurality of first electrode portions 51 is arranged so as to surround the resonator 2 has been described as a representative example, but the sensor element is not limited to such a form. For example, in the gyro sensor 1, as long as the sensor element can be regarded as the vibrating body of the two-degree-of-freedom system illustrated in FIG. 5, the control unit 10 can perform the control described above. Therefore, the form, arrangement, and the like of the resonator 2 and the electrode portions 51 and 52 may be other known forms, arrangement, and the like.

The control unit 10 and a method of the control unit described in the present disclosure may be achieved by a dedicated computer provided by configuring a processor and a memory programmed to execute one or a plurality of functions embodied by a computer program. Alternatively, the control unit 10 and the method of the control unit described in the present disclosure may be achieved by a dedicated computer provided by configuring a processor with one or more dedicated hardware logic circuits. Alternatively, the control unit 10 and the method of the control unit described in the present disclosure may be achieved by one or more dedicated computers configured by a combination of a processor and a memory programmed to execute one or a plurality of functions and a processor configured by one or more hardware logic circuits. The computer program may be stored in a computer-readable non-transitory tangible recording medium as an instruction executed by a computer.

In each of the embodiments, it goes without saying that the elements constituting the embodiments are not necessarily essential except for a case where it is explicitly stated that the elements are particularly essential and a case where the elements are considered to be obviously essential in principle. In each of the embodiments, when a numerical value such as the number, numerical value, amount, or range of the constituent elements of the embodiment is mentioned, the numerical value is not limited to a specific number unless otherwise specified as essential or obviously limited to the specific number in principle. In each of the embodiments, when referring to the shape, positional relationship, and the like of the constituent elements and the like, the shape, positional relationship, and the like are not limited unless otherwise specified or limited to a specific shape, positional relationship, and the like in principle.

What is claimed is:

1. A gyro sensor comprising:
a resonator having a first vibration mode and a second vibration mode having different resonance angle frequencies;
a mounting substrate including a plurality of electrodes facing the resonator; and
a control unit that performs drive control of the resonator, wherein a radial direction is defined about a virtual straight line along a thickness direction of the mounting substrate and passing through a center of a region surrounded by the plurality of electrodes, an x axis being the radial direction along a vibration direction of the first vibration mode, a y axis being the radial direction along a vibration direction of the second vibration mode,
the control unit includes
a first PLL that performs frequency control of a first drive signal for driving the resonator in the first vibration mode,
a second PLL that performs frequency control of a second drive signal for driving the resonator in the second vibration mode,
a detection gain ratio corrector that corrects a detection gain ratio that is a ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes,
a drive gain ratio corrector that corrects a drive gain ratio that is a ratio between a gain of the first drive signal to a first drive electrode for vibrating the resonator in the first vibration mode among the plurality of electrodes and a gain of the second drive signal to a second drive electrode for vibrating the resonator in the second vibration mode among the plurality of electrodes,
a first demodulation block that performs calculation of a first demodulation output based on the first detection signal and the first drive signal and a second demodulation output based on the first detection signal and the second drive signal,
a second demodulation block that performs calculation of a third demodulation output based on the second detection signal and the first drive signal and a fourth demodulation output based on the second detection signal and the second drive signal,
a first AGC that calculates a drive output for maintaining an amplitude in drive of the resonator in the first vibration mode on a basis of an output signal from the first demodulation block,
a second AGC that calculates a drive output for maintaining an amplitude in vibration of the resonator in the second vibration mode on a basis of an output signal from the second demodulation block,
an angular velocity calculator that executes calculation of an angular velocity applied from outside, and
a bias error corrector that calculates an angle at which the angular velocity calculated by the angular velocity calculator becomes a value closest to zero after correction of the detection gain ratio and the drive gain ratio, and determines the angle as a detection direction and a drive direction of vibration of the resonator.

2. The gyro sensor according to claim 1, wherein the detection gain ratio corrector performs matrix calculation to cancel the detection gain ratio by multiplying a matrix including 1/G_{pxy} that is a reciprocal of the detection gain ratio.

3. The gyro sensor according to claim 1, wherein the drive gain ratio corrector performs matrix calculation to cancel the drive gain ratio by multiplying a matrix including 1/G_{fxy} that is a reciprocal of the drive gain ratio.

4. A method for controlling a gyro sensor in which a resonator having a first vibration mode and a second vibration mode having different resonance angle frequencies is mounted on a mounting substrate including a plurality of electrodes facing the resonator, the method comprising:
maintaining drive of the resonator in the first vibration mode and the second vibration mode by using two PLLs;
calculating and determining a detection gain ratio that is a ratio between a gain of a first detection signal from a first detection electrode that detects vibration of the resonator on an x axis among the plurality of electrodes and a gain of a second detection signal from a second detection electrode that detects vibration of the resonator on a y axis among the plurality of electrodes, the x axis being a radial direction along a vibration direction of the first vibration mode, the y axis being a radial direction along a vibration direction of the second vibration mode, the radial direction being defined about a virtual straight line along a thickness direction of the mounting substrate and passes through a center of a region surrounded by the plurality of electrodes;
calculating and determining a drive gain ratio that is a ratio of a gain of a first drive signal to a first drive electrode for vibrating the resonator on the x axis among the plurality of electrodes to a gain of a second drive signal to a second drive electrode for vibrating the resonator on the y axis among the plurality of electrodes;
after determining the detection gain ratio and the drive gain ratio, while performing angle input and sweeping of a detection direction and a drive direction of vibration of the resonator in a range of 0° to 360°, calculating an angular velocity or a drive output for vibrating the resonator for each input angle and determining a value at which the angular velocity is closest to zero as a command value; and
determining the detection direction and the drive direction as an angle of the command value and measuring an angular velocity.
